(19) United States
(12) Patent Application Publication
(10) Pub. No.: US 2026/0214601 A1
(43) Pub. Date: Jul. 23, 2026

(54) METHODS, ARCHITECTURES, APPARATUSES AND SYSTEMS FOR SYNCHRONIZATION SIGNAL BLOCK ENHANCEMENT IN CELL-FREE MULTIPLE INPUT MULTIPLE OUTPUT DEPLOYMENTS

(71) Applicant: InterDigital Patent Holdings, Inc., Wilmington, DE (US)

(72) Inventors: Patrick Svedman, Stockholm (SE); Allan Yingming Tsai, Boonton, NJ (US); Kyle Jung-Lin Pan, Saint James, NY (US); Javier Lorca Hernando, Madrid (ES); Arman Shojaeifard, London (GB); Guodong Zhang, Woodbury, NY (US)

(21) Appl. No.: 19/138,818

(22) PCT Filed: Dec. 21, 2023
(86) PCT No.: PCT/US2023/085333

§ 371 Date: Jun. 13, 2025

Related U.S. Application Data
(60) Provisional application No. 63/434,192, filed on Dec. 21, 2022.

(51) Int. Cl. H04W 56/00; H04W 76/20

(52) U.S. Cl. CPC H04W 56/0015; H04W 76/20

(57) ABSTRACT

Procedures, methods, architectures, apparatuses, systems, devices, and computer program products are described for enhancement of synchronization signal/physical broadcast channel blocks (SSBs). For example, a number of SSBs associated with a plurality of transmission/reception points (TRPs) may be enhanced using a plurality of physical cell identifiers (PCIs). For example, available or actually transmitted SSBs from a plurality of TRPs may be signaled to wireless transmit/receive units (WTRUs), such as by system information or radio resource control (RRC) signaling. For example, SSB indexing may be enhanced using a plurality of PCIs. For example, a plurality of enhanced SSBs may be transmitted and/or received using frequency resources associated with a legacy synchronization raster or a non-legacy synchronization raster.

### CROSS-REFERENCE TO RELATED APPLICATIONS

This application claims the benefit of U.S. Provisional Patent Application No. 63/434,192 filed 21 Dec. 2022 which is incorporated herein by reference.

### TECHNICAL FIELD

The present disclosure is generally directed to the fields of communications, software and encoding, including, for example, to methods, architectures, apparatuses, systems directed to synchronization signal/physical broadcast channel block (SSB) enhancements in wireless communications, such as multiple input multiple output (MIMO) communication systems.

### BACKGROUND

Legacy cellular networks are based on the concept that a (e.g., typically) small number of transmission and reception points (TRPs) transmit and receive signals corresponding to a cell in a frequency band. The geographic area served by a cell is typically static. Handovers between cells typically occur at cell edges where the quality-of-service is typically lower. Techniques which allow for a cell serving a wireless transmit/receive unit (WTRU) to move with a WTRU may be desirable to reduce handovers and/or reduce quality-of-service deterioration at cell edges.

### SUMMARY

In certain representative embodiments, one or more wireless transmit/receive units (WTRUs) and/or base stations (e.g., gNBs) may communicate using increased numbers of transmission/reception points (TRPs) and/or beams. As an example, WTRUs and base stations may communicate within a cell-free MIMO deployment. An increased number of TRPs and/or beams may use and/or require an increased number of (e.g., beamformed) synchronization signals, and/or broadcast system information. For example, synchronization signals and/or broadcast system information may be transmitted (e.g., to WTRUs) in the form of SSBs, such as to support cell search and/or initial access. For example, the number of (e.g., distinguishable) SSBs may be increased by incorporating physical cell identity (PCI) information into the SSB transmissions. Enhanced PCI information in the SSBs may expand the number of SSBs available at a base station, e.g., for a cell. In certain representative embodiments, such as future cell-free deployments, there may be less of a need for many PCIs (e.g., for cell-planning purposes). In certain representative embodiments, a legacy SSB format may be used, such as for allowing legacy WTRUs to access a cell.

In certain representative embodiments, base stations and/or WTRUs may use enhanced signaling for SSBs which are transmitted and/or received, extended SSB indices, and/or synchronization rasters for SSB transmission.

In an example, a WTRU may receive (e.g., from a TRP) information indicating an ordered set of two or more index sets. Each of the index sets may include respective indices for a plurality of SSBs. Each index set may correspond to a respective PCI and/or a respective frequency layer. For example, each index set may correspond to a set of legacy indices. The WTRU 102 may determine a set of extended SSB indices of the SSBs based on correspondence with the ordered set. The WTRU 102 may receive one or more of the SSBs 402. The WTRU 102 may transmit information indicating at least one of the extended SSB indices of the received one or more of the SSBs 402.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a system diagram illustrating an example of points of communication as transmission and reception points (TRPs) and reception points (RPs);

FIG. 2B is a system diagram illustrating an example of TRPs which may be associated with a same geographic site;

FIG. 2C is a system diagram illustrating an example of points of communication associated with antenna panels;

FIG. 3 is a diagram illustrating example information carried by a master information block (MIB); and

FIG. 4A is a time-frequency diagram illustrating a first example of an arrangement of synchronization signal/physical broadcast channel blocks (SSBs);

FIG. 4B is a time-frequency diagram illustrating a second example of an arrangement of SSBs;

FIG. 4C is a time-frequency diagram illustrating a third example of an arrangement of SSBs;

FIG. 4D is a time-frequency diagram illustrating a fourth example of an arrangement of SSBs;

FIG. 5 is a system diagram illustrating a first example of a super cell;

FIG. 6 is a system diagram illustrating a second example of a super cell;

FIG. 7 is a procedural diagram illustrating an example process of a WTRU receiving SSBs using extended SSB indices; and

FIG. 8 is a procedural diagram illustrating an example process of a TRP sending SSBs using extended SSB indices.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

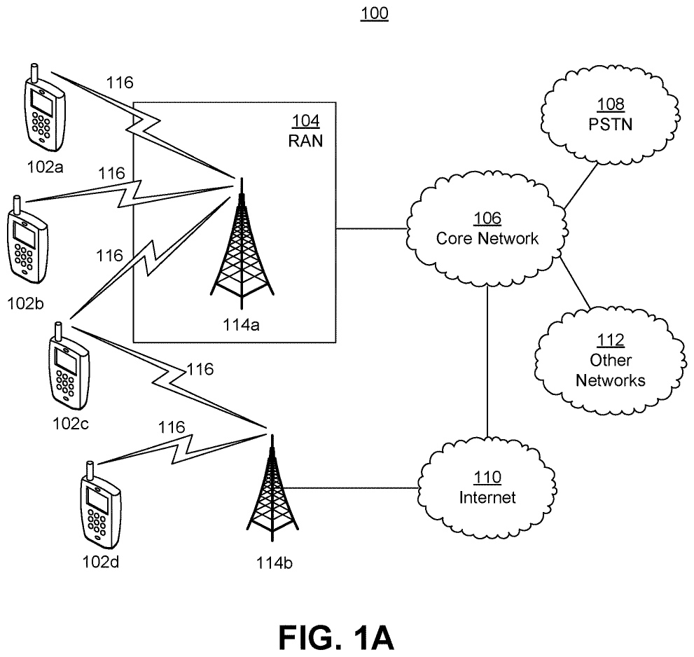

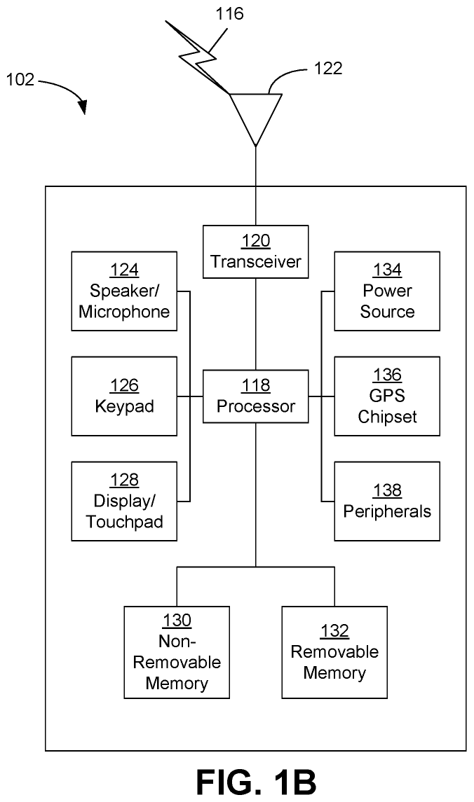

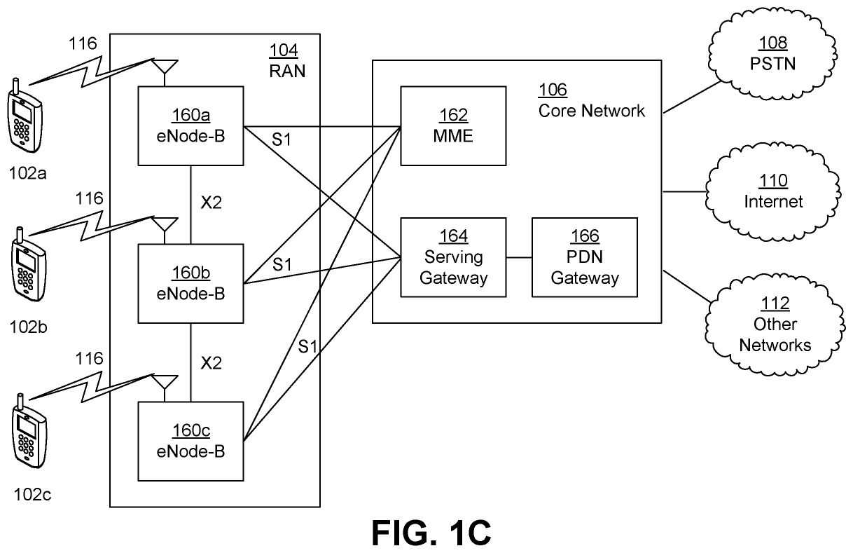

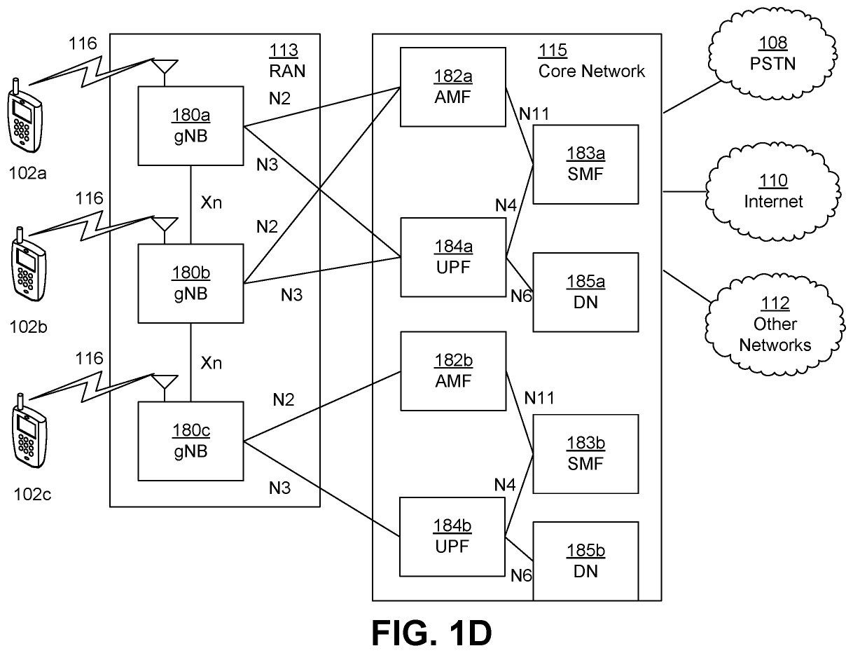

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

The following abbreviations and acronyms may be used throughout this disclosure.
ARFCN Absolute Radio-Frequency Channel Number
BWP Bandwidth Part
CCE Control Channel Element
CORESET Control Resource Set
CRAN Centralized RAN
CSI-RS Channel State Information RS
DCI Downlink Control Information
DL Downlink
DMRS Demodulation RS
FDD Frequency Division Duplex
FR Frequency Range (e.g., FR1 or FR2)
GSCN Global Synchronization Channel Number
IAB Integrated Access and Backhaul
ID Identity/Index
LSB Least Significant Bit
MAC Medium Access Control
MAC CE MAC Control Element
MIMO Multiple Input Multiple Output
MSB Most Significant Bit
MT Mobile Termination
MU-MIMO Multi-User MIMO
NTN Non-terrestrial Network
PCI Physical Cell Id
PUCCH Physical Uplink Control Channel
PUSCH Physical Uplink Shared Channel
QCL Quasi Co-location
RAN Radio Access Technology
REG Resource Element Group
RP Reception Point
RRC Radio Resource Control
RS Reference Signal
RSRP RS Received Power
SCell Secondary Cell
SFBC Space-Frequency Block Coding
SFN System Frame Number or Single Frequency Network
SI System Information
SIB System Information Block
SINR Signal to Interference plus Noise power Ratio
SNR Signal to Noise power Ratio
SRS Sounding RS
SSB Synchronization Signal/PBCH Block
STBC Space-Time Block Coding
TDD Time Division Duplex
TRP Transmission and Reception Point
TRS Tracking RS (also CSI-RS for tracking)
UL Uplink

### Overview

### MIMO Deployments—Introduction

In certain representative embodiments, wireless communication may be performed between one or more WTRUs 102 and a network. The network (e.g., in the vicinity of a particular WTRU 102) may include one or more transmission and reception points (TRPs). As used herein, TRPs may be referred to as any of a distributed antenna system (DAS), a remote radio head (RRH), an access point (AP), and/or distributed MIMO.

For example, a TRP may transmit one or more signals and/or channels to one or more WTRUs 102 (e.g., in the downlink (DL) direction), and/or may receive one or more signals and/or channels from one or more WTRUs 102 (e.g., in the uplink (UL) direction).

In some representative embodiments, a TRP may act as a WTRU 102, such as a relay WTRU. For example, a TRP may act as a WTRU 102 and interact with another node (e.g., relay WTRU or base station) to receive DL data which is then relayed to another (e.g., relay or remote) WTRU 102. For example, a TRP may act as a WTRU 102 and relay UL data received from a (e.g., relay or remote) WTRU 102 to or towards a base station.

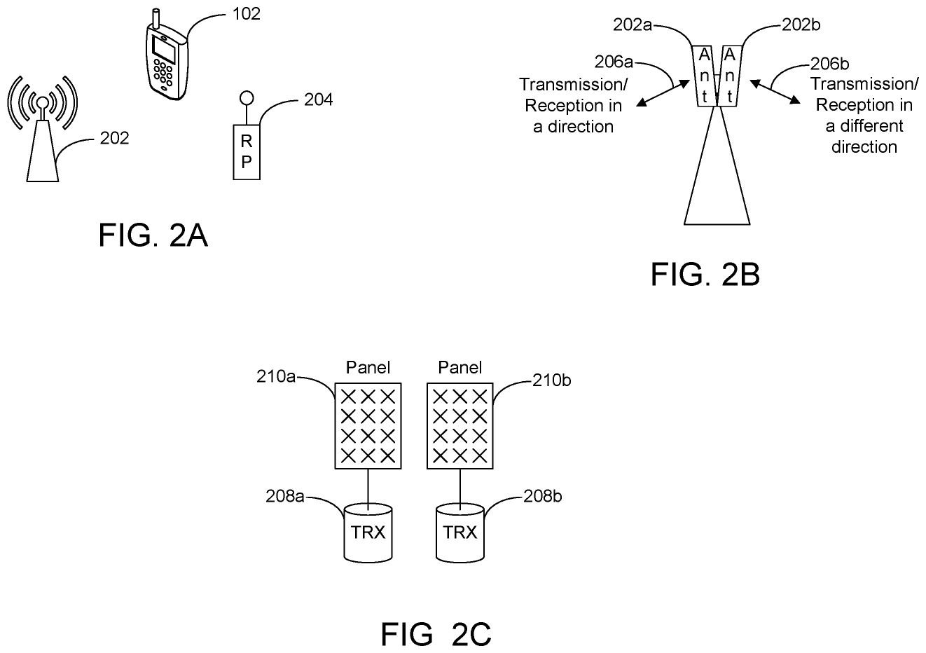

FIG. 2A is a system diagram illustrating an example of points of communication as transmission and reception points (TRPs) and reception points (RPs). In FIG. 2A, two geographically separate points, such as a TRP 202 and an RP 204, may be in the vicinity of a WTRU 102.

FIG. 2B is a system diagram illustrating an example of TRPs which may be associated with a same geographic site. In FIG. 2B, two points (e.g., TRPs 202a, 202b) having antenna(s) may be geographically located at a same site. The two points may have (e.g., main) transmission and/or reception directions (e.g., boresights) 206a, 206b in substantially different directions)

FIG. 2C is a system diagram illustrating an example of points of communication associated with antenna panels. In FIG. 2C, two transmitter and receiver chains (TRXs) 208a, 208b may act as communication points. Each TRX 208a, 208b may have an antenna panel 210a, 210b, such as a rectangular array of cross-polarized antenna elements.

In certain representative embodiments, different points (e.g., TRPs 202) may be geographically separated, such as in FIG. 2A. In certain representative embodiments, different points may be located in approximately the same geographical location but may be separated in some other way. For example, the boresight(s) of antenna(s) and/or antenna element(s) of a first point may be significantly different from the boresight(s) of the of antenna(s) and/or antenna element(s) of a second point.

An example cellular communication site may serve multiple sectors in different directions, such as by using different sets of antennas. In this case, the different sets of antennas serving different sectors in different directions from the site may be considered different points, such as in FIG. 2B.

In certain representative embodiments, antennas may be arranged in one or more panels, such as a panel having a rectangular panel with N×M antenna elements as in FIG. 2C. For example, any (e.g., all or a subset) of the antenna elements of a panel may be connected to a same TRX chain or a same receiver (RX) chain. For example, antenna elements of different panels may be connected to different TRX chains or different RX chains. In some examples, different panels, which may or may not be geographically co-located, may correspond to different points. In some examples, different panels may correspond to a same point.

In certain representative embodiments, a communication point may operate on multiple frequencies, for example, two (e.g., operating) frequencies. In some representative embodiments, a site (e.g., one antenna, an antenna array, a panel, a subset of antennas per frequency) in a geographic location with a particular transmission and/or reception direction on the multiple frequencies may act as multiple points (e.g., at least from the point of view of a WTRU 102). Radio signal propagation properties on the different frequencies may be different. Capabilities (e.g., hardware capabilities) at the network side may result in signal transmission and/or reception differences on the different frequencies, such as different oscillators, calibration hardware for beam correspondence, phase shifters for beamforming, etc.

A signal and/or channel received at a TRP 202 may be subject to further processing, such as filtering, amplification, down-conversion, A/D conversion (sampling), digital signal processing, demodulation, channel decoding, etc. A signal and/or channel transmitted at a TRP may be subject to various processing prior to transmission, such as filtering, amplification, peak-to-average power reduction, up-conversion, D/A conversion, digital signal processing, modulation, channel encoding, etc. A subset (e.g., none, some, or all) of these operations for reception and/or transmission may be performed at a TRP 202 while other operations may be performed at one or more other location(s) connected with the TRP 202, such as through a fronthaul or backhaul link, by optical fiber, copper wire, and/or over-the-air. As an example of a centralized RAN (CRAN) implementation, signal processing for multiple points may be performed at a centralized location.

### MIMO Deployments—Massively Distributed MIMO

In certain representative embodiments, additional TRPs 202 in a cell may reduce average distance and pathloss between a WTRU 102 and a (e.g., nearest) TRP 202, and/or may allow for using lower transmit power and hence lower interference in the system. Additional TRPs 202 in a cell may improve spatial diversity, and several candidate TRPs 202 may possibly be used to serve a WTRU 102. For example, where the radio link to a serving TRP 202 is blocked, the WTRU 102 may instead be served by another TRP 202 without a blocked radio link.

In distributed MIMO systems, antennas may not be located at one or a few TRPs 202. Antennas may be more distributed throughout the wireless network. In some examples, distributed MIMO may include scenarios with a few TRPs 202, such as coherent joint transmission/reception involving a few TRPs 202.

A massively distributed MIMO system (also called distributed massive MIMO) may combine the larger numbers of antennas in a massive MIMO system with the distributed antennas in a distributed MIMO system. For example, hundreds of antennas previously co-located at a massive MIMO TRP that covers a geographic area may be distributed throughout an area. Subsets of antennas may be co-located at TRPs 202. Massively distributed MIMO deployments are predicted to achieve high theoretical performance under ideal assumptions. However, there are numerous challenges to achieve those performance gains in practice, including fronthaul, synchronization, etc.

### MIMO Deployments—Cell-Free MIMO

For example, legacy cellular networks may be based on the concept that a (e.g., typically) small number of TRPs transmit and/or receive signals corresponding to a cell in a frequency band.

In certain representative embodiments, a frequency band in which multiple cells operate may be referred to as a frequency layer. A frequency layer may be characterized by a range of frequencies, a center (e.g., carrier) frequency, a bandwidth, etc. For example, different cells on a frequency layer may use the same or different center frequencies and/or bandwidths.

In certain representative embodiments, a geographic area served by a cell may be (e.g., typically) considered to be static. As a WTRU 102 moves through the network, the WTRU 102 may need to be handed over from cell to cell. Intra-frequency handovers (e.g., handovers between cells in the same frequency band) typically occur at cell edges, where quality-of-service may typically be expected to be lower.

In certain representative embodiments, a WTRU 102 may be configured for cell-free operation. Opposed to moving across more or less static cells, the cell serving a WTRU 102 may move with the WTRU 102. From the WTRU's perspective few, if any, intra-frequency handovers may be needed.

With cell-free operation, deteriorations in quality-of-service at cell edges may be avoided. For example, a set of nearby TRPs 202 may serve a WTRU 102 (e.g., rather than using a set of TRPs that need to be associated with the serving cell).

For example, it may be attractive to use cell-free operation in a massively distributed MIMO deployment, which may otherwise be referred to as cell-free MIMO. In certain representative embodiments, a WTRU-centric cell may be operated by one or more TRPs 202 and/or antennas that are close to the WTRU 102, which may result in high and uniform quality-of-service.

### SS/PBCH Blocks (SSBs) in 5G NR—Introduction

In certain representative embodiments, a SS/PBCH block (SSB) may refer to signals and/or channels in 5G NR which are (e.g., most) connected to cell-based operation.

In certain representative embodiments, a SSB may include any of a primary synchronization signal (PSS), a secondary synchronization signal (SSS), a physical broadcast channel (PBCH), and/or a PBCH demodulation reference signal (DMRS).

In certain representative embodiments, a plurality of SSBs may be used in a cell. For example, there may be up to 4, 8, or 64 SSBs in a cell. The number of SSBs may depend on the frequency range of the cell. As an example, lower frequencies (e.g., frequency ranges) may support fewer SSBs while higher frequencies (e.g., frequency ranges), such as millimeter wave ranges, may support more SSBs in a cell. Different SSBs may correspond to and/or be associated with different SSB indices.

In certain representative embodiments, for various reasons, an SSB (e.g., with a certain SSB index) might not be transmitted on a nominal time-frequency resource assigned to the SSB. Hence, it may be more suitable to denote SSBs as candidate SSBs and to denote an SSB index as a candidate SSB index. The terms SSB and SSB index are used herein, but they may refer to candidate SSB and candidate SSB index, respectively.

### SS/PBCH Blocks (SSBs) in 5G NR—PCI

In certain representative embodiments, physical cell identification information may be used to identify a cell. For example, a physical cell identifier (PCI) may be used to identify a cell, such as on or for a carrier frequency. For example, a PCI may also be used to generate various cell-specific signals and/or channels, such as PSS and/or SSS.

As an example, a 5G NR PCI

$${N}_{ID}^{cell} ∈ \{ 0 , 1 , … , 1008 \}$$

may be constructed from two other IDs,

$${N}_{ID}^{( 1 )} ∈ \{ 0 , 1 , … , 335 \} and {N}_{ID}^{( 2 )} ∈ \{ 0 , 1 , 2 \} , as {N}_{ID}^{cell} = 3 {N}_{ID}^{( 1 )} + {N}_{ID}^{( 2 )}$$

### SS/PBCH Blocks (SSBs) in 5G NR—Primary Synchronization Signal (PSS)

In certain representative embodiments, a PSS may be used by a WTRU 102, for example, for cell search and/or coarse time- and frequency synchronization. For example, a sequence used for PSS may be

$${N}_{ID}^{( 2 )} .$$

### SS/PBCH Blocks (SSBs) in 5G NR—Secondary Synchronization Signal (SSS)

In certain representative embodiments, a SSS may be used by a WTRU 102, for example, for further synchronization, channel estimation, SSB-based measurements, such as reference signal received power (RSRP), and/or determining the PCI. For example, a sequence used for SSS may be based on

$${N}_{ID}^{( 1 )} and / or {N}_{ID}^{( 2 )} .$$

### SS/PBCH Blocks (SSBs) in 5G NR—PBCH Demodulation RS (PBCH DMRS)

In certain representative embodiments, a PBCH DMRS may be used by a WTRU 102. For example, a PBCH DMRS may be used for further synchronization, channel estimation, and/or SSB-based measurements (e.g., in addition to the SSS measurements).

In certain representative embodiments, a PBCH DMRS sequence may be based on the PCI and/or the SSB index (e.g., the least significant bits (LSB) thereof). For example, the PBCH DMRS sequence may be based on any of the PCI, SSB index, and/or a half-frame index. A WTRU 102 may obtain some degree of sub-frame and/or frame timing upon reception of a PBCH DMRS.

In certain representative embodiments, a sub-carrier offset may be applied to the PBCH DMRS. As an example, the sub-carrier offset may be based on the PCI mod 4.

### SS/PBCH Blocks (SSBs) in 5G NR—PBCH

In certain representative embodiments, a PBCH payload (e.g., of a transmitted SSB) may include a master information block (MIB) and/or timing-related information (e.g., a number of bits, such as 8 bits). For example, the timing-related information may not be included in the MIB. As an example, the timing-related information may include (e.g., the most significant bits (MSB) of) the SSB index and/or the half-frame index.

### SS/PBCH Blocks (SSBs) in 5G NR—Master Information Block (MIB)

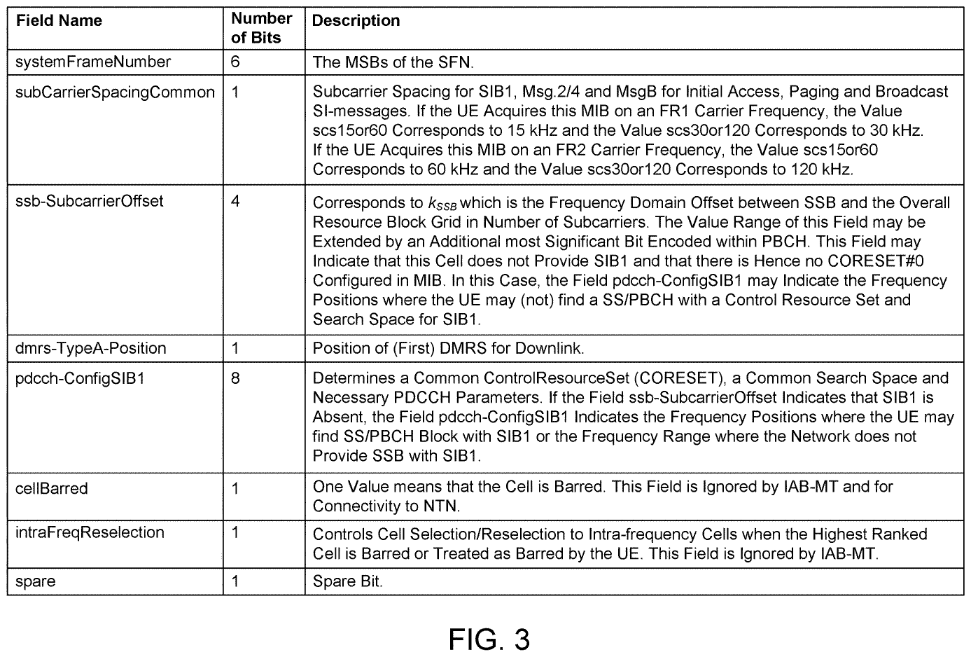

In certain representative embodiments, a MIB may include information associated with (e.g., necessary for) reception of system information, such as SIB1 as well as other information. FIG. 3 is a diagram illustrating example information carried by a MIB. For example, a MIB may include any of the following: a systemFrameNumber field (e.g., 6 bits), a subCarrierSpacingCommon field (e.g., 1 bit), a ssb-SubcarrierOffset field (e.g., 4 bits), a dmrs-TypeA-Position field (e.g., 1 bit), a pdcch-ConfigSIB1 field (e.g., 8 bits), a cellBarred field (e.g., 1 bit), an intraFreqReselection field (e.g., 1 bit), and/or a spare field (e.g., 1 bit). The systemFrameNumber field may indicate the MSBs of the system frame number (SFN). The subCarrierSpacingCommon field may indicate the subcarrier spacing for SIB1, Msg. 2/4 and Msg B for initial access, paging and broadcast SI-messages. If the WTRU 102 acquires this MIB on a FR1 carrier frequency, the value scs15 or 60 Corresponds to 15 khz and the Value scs30 or 120 Corresponds to 30 khz. If the WTRU 102 acquires this MIB on an FR2 carrier frequency, the value scs 15 or 60 corresponds to 60 KHz and the value scs30 or 120 corresponds to 120 KHz. The ssb-SubcarrierOffset field may indicate and correspond to kssB which is the frequency domain offset between SSB and the overall resource block grid in number of subcarriers. The value range of this field may be extended by an additional MSB encoded within PBCH. This field may indicate that this cell does not provide SIB1 and that there is hence no CORESET #0 configured in MIB. In this case, the field pdcch-ConfigSIB1 may indicate the frequency positions where the WTRU 102 may (not) find a SS/PBCH with a control resource set and search space for SIB1. The dmrs-TypeA-Position field may indicate a position of a (e.g., first) DMRS for DL. The pdcch-ConfigSIB1 field may indicate a common CORESET, a common search space, and necessary PDCCH parameters. If the ssb-SubcarrierOffset field indicates that SIB1 is absent, the field pdcch-ConfigSIB1 indicates the frequency positions where the WTRU 102 may find a SS/PBCH block with SIB1 or the frequency range where the network does not provide SSB with SIB1. The cellBarred field may indicate whether or not the cell is barred. This field may be ignored by IAB-MT and for connectivity to NTN. The intraFreqReselection field may control cell selection and/or reselection to intra-frequency cells when the highest ranked cell is barred or treated as barred by the WTRU 102. This field may be ignored by IAB-MT. The spare field may provide a spare bit.

In certain representative embodiments, one or more cells may not support initial access and/or may not provide (e.g., transmit) system information, such as SIB1. For example, certain values of the subcarrier offset kssB (or ssb-SubcarrierOffset) may indicate that SIB1 is not broadcast on the cell. For example, if a WTRU 102 cannot proceed with initial access on the cell, the WTRU 102 may not need to know the subcarrier offset.

For example, a cell may provide SIB1, and the system information (e.g., pdcch-ConfigSIB1) may include an information element with a 4-bit field (e.g., controlResourceSetZero) that determines a common CORESET with ID #0 and/or a 4-bit field (e.g., searchSpaceZero) that determines a common search space with ID #0.

For example, a cell may not provide SIB1, such as for kssp within a certain (e.g., predetermined) range, and the value of kssB and/or the system information (e.g., pdcch-ConfigSIB1) may provide an indication of another global synchronization channel number (GSCN) that does provide SIB1.

Cell-free MIMO deployments may be an attractive alternative to legacy cell-based (e.g., cellular) networks. The overhead and potential disruptions associated with handling cells may be reduced while the benefits of multi-TRP based operation can be retained.

For example, an aspect of legacy systems that is fundamentally linked to cells is cell search. In 5G NR, for example, cell search is based on SSBs, where different SSBs may be transmitted from different TRPs 202 or with different Tx beams from a TRP 202. In existing 5G NR specifications, there may be up to 4 or 8 SSBs in FR1, and up to 64 SSBs in FR2.

For example, different SSBs in a cell may be time multiplexed. One reason is that this allows base stations to be implemented using analog beamforming, in which a single Tx beam may be used at a time. Another reason is that this may allow any (e.g., all) available base station transmit power to be assigned to one SSB, thereby maximizing SSB coverage. In general, SSBs are fundamental signals for various aspects of 5G NR, not only time-frequency synchronization, but also beam management, mobility measurements, etc. In systems with multiple TRPs 202 and/or TRPs 202 with hybrid/digital beamforming, time multiplexing of SSBs may not be necessary.

In future cell-free MIMO deployments, the number of TRPs 202 and beams may need to be increased (e.g., dramatically). For example, this may (e.g., require to) use a much higher number of SSBs.

In certain representative embodiments, one or more WTRUs 102 may perform cell-free operation using one or more TRPs 202. For example, an area in which the WTRU 102 operates as cell-free may be referred to as a super-cell. An increased number of SSBs may be used (e.g., transmitted/received) in a super-cell.

In certain representative embodiments, one or more TRPs 202 may support cell-free operation for one or more WTRUs. For example, an area in which one or more TRPs 202 support WTRU cell-free operation may be referred to as a super-cell. An increased number of SSBs may be used (e.g., transmitted) by any of the TRPs 202 in a super-cell.

### Super Cell

In certain representative embodiments, a system, such as a cell-free system, of WTRUs 102 and/or TRPs 202 may operate. For example, a cell-free system may be a system which supports cell-free operation in one or more (e.g., large) geographic areas. For example, a system (e.g., of WTRUs and/or TRPs) that is cell-free over a large geographic area may expand the geographic size of a cell so that an area covered by multiple cells in a legacy cellular deployment may be covered by a single cell (e.g., on at least one frequency layer) in certain representative embodiments of cell-free systems. The TRPs 202 that could serve a multitude of cells in a legacy cellular deployment may serve a same cell (e.g., a super cell) in certain representative embodiments. The number of TRPs 202 in the super cell may be much higher than the number of TRPs 202 per cell in a legacy cellular deployment. In certain representative embodiments, an area covered by a super cell may, for example, be a city or a part of a city, a suburb, an airport, a harbor, a highway, etc. In some representative embodiments, a deployment of a cell-free system (e.g., on a frequency layer) might not be completely without cells, but rather with (e.g., sizably) larger super cells (e.g., than a legacy deployment).

As an example, as a number of TRPs and/or beams increase (e.g., to very large numbers of TRPs and/or beams in a super cell), a maximum number of SSBs (e.g., 64 SSBs) may not be sufficient.

In certain representative embodiments, a maximum number of SSBs may be increased by enhancements to a SSB transmission pattern. For example, the SSB transmission pattern may be enhanced by adding more time multiplexed SSBs in a SSB period. In some cases, such an enhancement may introduce a non-backwards compatible change to the SSBs and/or may cause legacy NR WTRUs to be unable to access the super cell.

In certain representative embodiments, legacy SSB transmission patterns may be taken into consideration. For example, a maximum number of different SSBs that may be distinguished in a super cell may be increased by including SSBs with different PCIs. For example, physical cell identification information, such as a PCI

$$( e . g . , {N}_{ID}^{cell} ) ,$$

may be used to generate one or more signals and/or channels in an SSB. For example, a WTRU may receive multiple SSBs corresponding to different PCIs (e.g., on the same time-frequency resources). Due to the dependency on the PCI and the robustness of the SSB, the WTRU 102 may (e.g., reliably) process (e.g., decode, measure, synchronize to, etc.) the multiple SSBs.

As described herein, a super cell may refer to a cell in a “cell-free” MIMO deployment (e.g., to avoid confusing PCI with cell).

As described herein, a SSB is used as an example synchronization signal and/or physical broadcast channel. Certain embodiments and examples described herein may be applicable to other kinds of synchronization signals and/or broadcast information that may be beamformed and/or may be transmitted from different TRPs 202 in a wireless network.

In certain representative embodiments, a SSB (e.g., in a super cell) may have a PCI selected from a set of PCIs, [symbol] , where [symbol] includes P PCIs. Hence, the number of distinguishable SSBs may be increased by a factor P (e.g., in a super cell). For example, in a case that a SSB pattern supports a maximum number of SSBs equal to 64 and P is 4, then the number of distinguishable SSBs may increased from 64 to 256. For example, a set P may be predefined, configured (e.g., in SIB1, other SIBs, PBCH, MIB, or dedicated RRC signaling), and/or derived by a rule and/or procedure. For example, a WTRU 102 may detect an SSB with a PCI. From the PCI of the detected SSB, the WTRU 102 may determine a set P that includes the detected PCI (e.g., based on predefined sets, configuration, rules, etc.).

### Transmitted SSBs

In certain representative embodiments, a subset (e.g., only a subset) of the maximum number of SSBs may actually be transmitted (e.g., from the one or more TRPs), such as in a super cell. For example, a network may provide information which indicates to a WTRU 102 the subset of actually transmitted SSBs. As an example, a subset of SSBs which are actually transmitted may be indicated using the parameter ssb-PositionsinBurst in any of SIB1 and/or dedicated RRC signaling.

For example, such as in legacy 5G NR, a parameter ssb-PositionsinBurst in SIB1 may comprise a first 8-bit parameter inOneGroup and optionally (e.g., in FR2) a second 8-bit parameter groupPresence. The parameter inOneGroup may be a bitmap indicating the presence of up to 8 SSBs (e.g., a group). In FR2, with up to 64 SSBs, the parameter groupPresence may be a bitmap indicating the presence of up to 8 SSB groups, with the SSB presence within each of the groups being determined by the inOneGroup parameter.

In certain representative embodiments, such as in a super cell, information may indicate which SSBs for multiple PCIs (e.g., for all PCIs in [symbol] ) are actually transmitted. In some representative embodiments, legacy signaling may be used (e.g., as described herein) and a WTRU 102 may assume that the actually transmitted SSBs are the same for multiple PCIs (e.g., for all PCIs in [symbol] ), such as in a super cell. In some representative embodiments, system information (e.g., SIB1) may include multiple parameters (e.g., inOneGroup) each corresponding to at least one PCI in the super cell. For example, a set of actually transmitted SSBs indicated by inOneGroup may be different for different PCIs in the super cell.

As an example, system information, such as in FR2, may include multiple parameters (e.g., groupPresence in SIB1) each corresponding to a PCI in the super cell. The multiple parameters may (e.g., each) indicate a different presence of SSB groups in different PCIs.

As another example, system information may include multiple parameters (e.g., inOneGroup and groupPresence are indicated), a first parameter (e.g., inOneGroup) may be applicable to multiple PCIs, and multiple second parameters (e.g., groupPresence) may each correspond to at least one PCI in the super cell. The same SSBs within a group may be present for the multiple PCIs, while different (or the same) groups may be present for different PCIs.

As another example, system information may include multiple parameters (e.g., inOneGroup and groupPresence are indicated). A first parameter (e.g., groupPresence) may be applicable to multiple PCIs, and multiple second parameters (e.g., inOneGroup) may each correspond to at least one PCI in the super cell. The same groups may be present for multiple PCIs, and different (or the same) SSBs within a group may be present for different PCIs.

For example, such as in legacy 5G NR, a parameter ssb-PositionsinBurst in dedicated RRC signaling may include a bitmap of a length equal to a maximum number of SSBs (e.g., a 4-bit, 8-bit, or 64-bit bitmap) that may indicate per SSB whether an SSB is actually transmitted.

In certain representative embodiments, such as in a super cell, legacy dedicated RRC signaling may be used to indicate whether an SSB is actually transmitted. For example, a single bitmap may be included in an RRC configuration. A WTRU 102 may assume that the actually transmitted SSBs are the same for multiple PCIs in the super cell (e.g., for all PCIs in P) according to the single bitmap. As another example, an RRC configuration received with dedicated RRC signaling may include multiple parameters (e.g., ssb-PositionsinBurst), such as multiple bitmaps, each corresponding to a PCI in the super cell. A set of actually transmitted SSBs may be different for different PCIs in the super cell and indicated by a respective one of the bitmaps.

### Extended SSB Index

In certain representative embodiments, such as in a super cell, a SSB may be identified by an extended SSB index. For example, an extended SSB index may be based on a function of an SSB index among SSBs with a PCI (e.g., a legacy SSB index) and an index corresponding to a PCI in [symbol] . In certain representative embodiments, an extended SSB index i may be given by the following:

$$i = {i}_{leg} + {pN}_{SSB} \qquad ( 1 )$$

In Equation (1) above, the term i_{leg} may correspond to a legacy SSB index, or to an index among the actually transmitted SSBs, where the set of actually transmitted SSBs may be configured (e.g., in SIB1 or with dedicated RRC signaling). The term N_{SSB} may correspond to a maximum number of SSBs (e.g., for the frequency range of the cell), or to the number of actually transmitted SSBs. The term p may correspond to an index of the PCI of the SSB, for example with p∈{0 1 . . . . P−1}. In other words, the set of PCIs [symbol] may be ordered, with the PCI corresponding to p=0 being a first PCI, the PCI corresponding to p=1 being a second PCI, etc.

As an example of 64 SSBs per PCI and 4 PCIs in the super cell (P=4), the extended SSB indices 0-63 may correspond to a first PCI, the extended SSB indices 64-127 may correspond to a second PCI, the extended SSB indices 128-191 may correspond to a third PCI, and/or the extended SSB indices 192-255 may correspond to a fourth PCI.

In certain representative embodiments, different PCIs in [symbol] may have different numbers of actually transmitted SSBs, and an extended SSB index i may be given by the following:

$$i = {i}_{leg} + {\sum }_{j = 0}^{p - 1} {N}_{SSB}^{j} \qquad ( 2 )$$

In Equation (2) above, the term

$${N}_{S S B}^{j}$$

may correspond to a number of actually transmitted SSBs with a PCI in P with index j. For example, the extended SSB index of SSBs with a first PCI in [symbol] (with index p=0) may be based on the legacy SSB index (i_{leg}). The extended SSB index of SSBs with a second PCI in [symbol] (with index p=1) may be based on the legacy SSB index plus the number of actually transmitted SSBs with the first PCI

$$( {N}_{SSB}^{0} ) ( e . g . , i = {i}_{leg} + {N}_{SSB}^{0} ) .$$

In certain representative embodiments, an extended SSB index may be used by the network to indicate to a WTRU 102 which SSB to use. For example, an SSB may be indicated to use as a QCL source, and/or CSI measurement and reporting. For example, one or more SSBs may be indicated to be included in an SSB resource set that may be used for configuration of CSI measurement and reporting, using extended SSB indices. An extended SSB index may be used by the WTRU 102 to indicate to the network a reference signal corresponding to a measurement and/or CSI report.

### Time/Frequency Resources of SSBs

In certain representative embodiments, such as in a super cell, there may be one system frame timing (e.g., similar to a system frame timing being defined per cell in a legacy cellular network). For example, different SSBs with a same (or different) PCI may be received with slightly different timing, such as due to different propagation delay from different TRPs and/or beams, and/or slightly different transmission timing (e.g., clocks/oscillators in different TRPs may not be perfectly synchronized).

In certain representative embodiments, one or more SSBs with a first PCI (e.g., in a super cell) may be transmitted and/or received in a same or different system frame as one or more SSBs with a second PCI (e.g., in the super cell). The SSBs with the first PCI may be transmitted/received in the same or different half frame as the SSBs with a second PCI.

In certain representative embodiments, one or more SSBs with a first PCI (e.g., in a super cell) may be transmitted and/or received on a same or different frequency (e.g., in terms of SSB center frequency, GSCN, etc.) as one or more SSBs with a second PCI.

In certain representative embodiments, a WTRU 102 may be expected to handle multiple SSBs with different PCIs (e.g., in a super cell). For example, a SSB numerology (e.g., sub-carrier spacing, cyclic prefix, symbol duration, etc.) may be the same for all PCIs in [symbol] . For example, SSBs with different PCIs (from [symbol] ) may have different numerologies, such as where radio conditions, provided services, and/or the like differ (e.g., vary significantly within a super cell). For simplicity of description, various embodiments and examples herein use the assumption that (e.g., all) SSBs in a super cell have the same numerology. In other embodiments, any SSBs in a super cell may have different numerologies.

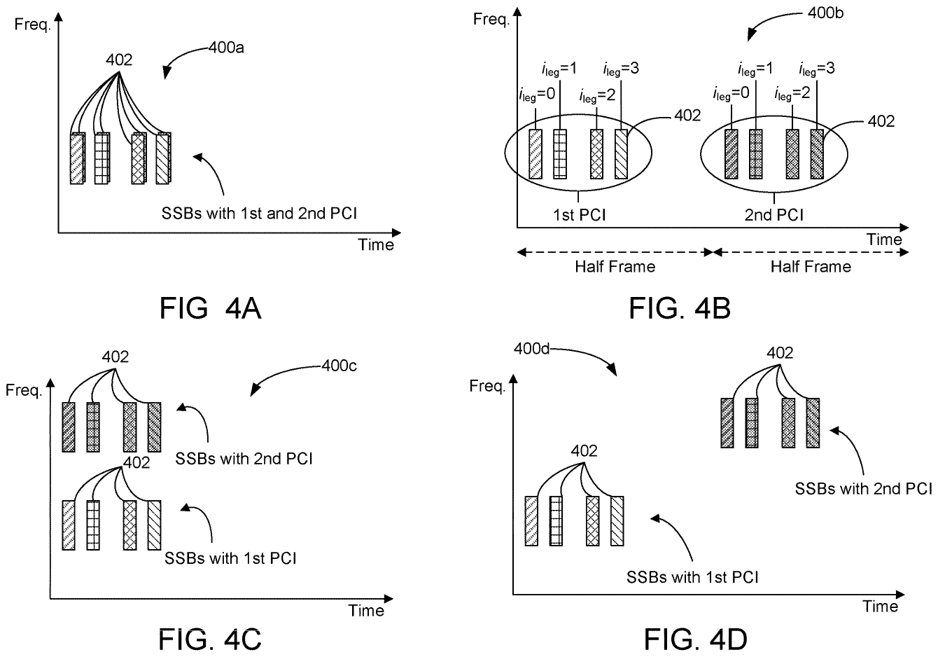

FIG. 4A is a time-frequency diagram illustrating a first example 400a of an arrangement of SSBs 402. As an example only, four SSBs 402 per PCI and two PCIs in a super-cell are assumed (e.g., N_{SSB}=4 and P=2). In FIG. 4A, the SSBs 402 associated with a first PCI overlap in time and frequency with the SSBs 402 with a second PCI. The SSBs 402 with the first PCI with a legacy SSB index i_{leg} overlap with the SSBs 402 with the second PCI with the same legacy SSB index. For example, with one system frame timing in a super cell, SSBs 402 for both PCIs may be located in the same system frame and half frame, and the same SSB pattern and/or numerology may be used for both PCIs.

FIG. 4B is a time-frequency diagram illustrating a second example 400b of an arrangement of SSBs 402. As an example only, four SSBs 402 per PCI and two PCIs in a super-cell are assumed (e.g., N_{SSB}=4 and P=2). In FIG. 4B, the SSBs 402 with the first PCI and the SSBs with the second PCI may occupy a same frequency band. The SSBs 402 may not overlap in time. For example, with one system frame timing in a super cell, the SSBs 402 with the first PCI may be located in a different half-frame than the SSBs 402 with the second PCI (e.g., shaded in FIG. 4B). The different half-frames may be consecutive or non-consecutive and/or may be in the same or different system frames.

FIG. 4C is a time-frequency diagram illustrating a third example 400c of an arrangement of SSBs 402. As an example only, four SSBs 402 per PCI and two PCIs in a super-cell are assumed (e.g., N_{SSB}=4 and P=2). In FIG. 4C, the SSBs 402 with the first PCI and the SSBs 402 with the second PCI (e.g., shaded in FIG. 4C) may occupy the same time resources (e.g., symbols), such as for a same system frame and half-frame. In FIG. 4C, the SSBs 402 may not overlap in frequency. For example, the SSBs 402 with the first PCI may be located on a first GSCN while the SSBs 402 with the second PCI may be located on a second GSCN. The SSBs 402 on the different frequencies may still be considered part of a same frequency layer and/or carrier, such as where the SSBs 402 on the different frequencies may be received within a WTRU receiver bandwidth.

FIG. 4D is a time-frequency diagram illustrating a fourth example 400d of an arrangement of SSBs 402. As an example only, four SSBs 402 per PCI and two PCIs in a super-cell are assumed (e.g., N_{SSB}=4 and P=2). In FIG. 4D, the SSBs with the first PCI and the SSBs with the second PCI (e.g., shaded in FIG. 4D) may be separated in both time and frequency (e.g., as in FIGS. 4B and 4C).

In some embodiments, overlapping SSBs 402 with different PCIs, such as in FIG. 4A, may be advantageous for several reasons. For example, less WTRU 102 effort may be required to receive any (e.g., all) SSBs 402 in the super cell, since the SSBs 402 may all be concentrated in time and frequency. For example, a WTRU 102 may apply efficient signal processing techniques to detect and measure different overlapping synchronization signals, such as PSS and SSS, resulting in further reduced WTRU complexity. For example, overlapping SSBs 402 may leave more time-frequency resources for other signals and/or channels, thereby increasing system spectral efficiency and capacity.

In some embodiments, time multiplexed sets of SSBs 402, such as in FIGS. 4B and/or 4D, may be advantageous in that WTRUs 102 with analog or hybrid Rx beamforming may have an easier task tracking the WTRX Rx beams for different SSBs 402, such as when the SSB periodicity is longer.

In some embodiments, with SSBs 402 not overlapping in frequency, such as in FIGS. 4C and/or 4D, the SSBs 402 with the first PCI may be located on a first GSCN, while the SSBs 402 with the second PCI may be located of the GSCN grid. For example, this may prevent WTRUs 102 from performing initial access using the SSBs 402 with the second PCI, which may be beneficial if the SSBs 402 with the second PCI introduce and/or are associated with a non-backwards compatible enhancement. In another example, the SSBs 402 not overlapping in frequency may use a same PCI. The different sets of SSBs 402 (e.g., on different frequencies) may be identified by some other ID, like a frequency index, such as an Absolute Radio-Frequency Channel Number (ARFCN) or a part thereof (e.g., the least significant bits). In some representative embodiments, the SSBs 402 in a super cell may be identified using a frequency index instead of, or in addition to, a PCI.

In some representative embodiments, SSBs 402 may be arranged in time and/or frequency resources based on a combination of arrangements as shown, for example, in any of FIGS. 4A, 4B, 4C, and/or 4D.

In certain representative embodiments, (e.g., any) SSBs 402 in a super cell may be located on a frequency belonging to a synchronization raster (e.g., a Global Synchronization Channel Number (GSCN)). For example, a legacy WTRU 102 searching using the raster may detect the SSBs 402.

In certain representative embodiments, (e.g., any) SSBs 402 in a super cell may be located on a frequency belonging to a new synchronization raster. For example, an enhanced WTRU 102 (e.g., but not a legacy WTRU) may detect a SSB 402 in the super cell during cell search based on a synchronization raster. For example, SSBs 402 for any (e.g., all) PCIs in a super cell may be on the same raster (e.g., an enhanced synchronization raster). For example, SSBs 402 for different PCIs in a super cell may be on different rasters (e.g., SSBs with a first PCI in a super cell are on a legacy synchronization raster, while SSBs 402 with a second PCI in the super cell are on an enhanced synchronization raster).

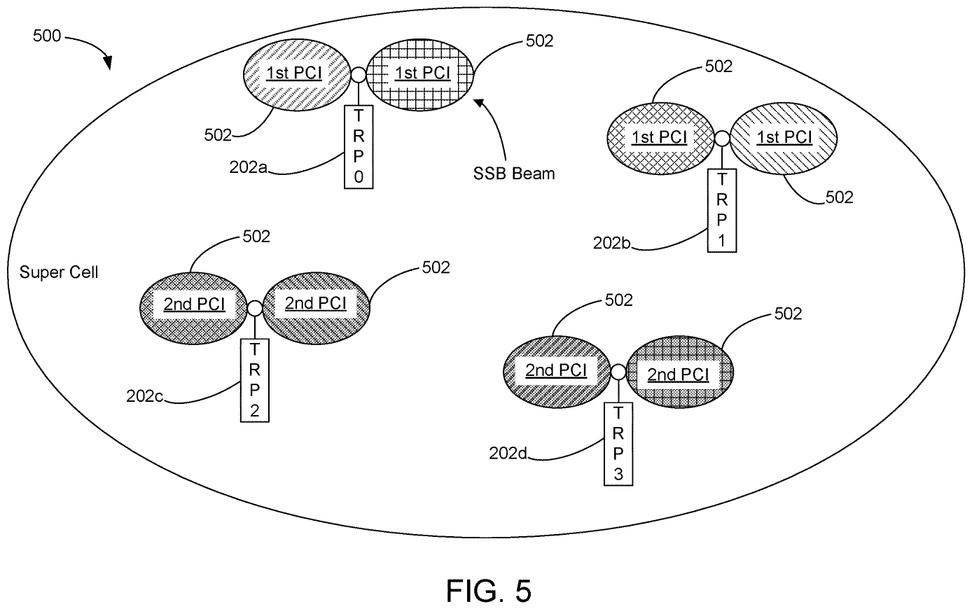

FIG. 5 is a system diagram illustrating a first example of a super cell 500. In FIG. 5, a cell-free deployment with a super cell 500 is shown. In FIG. 5, four TRPs (e.g., TRPs #0 to 3) 202a, 202b, 202c, 202d may provide super cell coverage. As an example only, two SSB beams 502 are shown per TRP 202. For example, a respective TRP 202 may transmit two SSBs 402, each with a same PCI, as SSB beams 502. As in FIG. 4C, different patterns in the SSB beams 502 may correspond to different legacy SSB indices. In FIG. 5, two TRPs 202a, 202b may transmit SSBs 402 with a first PCI, and another two TRPs 202c, 202d may transmit SSBs 402 with a second PCI.

In some embodiments, a legacy cellular deployment may be provided by one or more TRPs 202, such as with TRP #0 202a and/or TRP #1 202b serving a legacy cell with the 1^{st} PCI, and/or TRP #2 202c and/or TRP #3 202d serving a legacy cell with the 2^{nd} PCI. As described herein, the two PCIs may be joined together in a super cell with methods that are different from a state-of-the-art system.

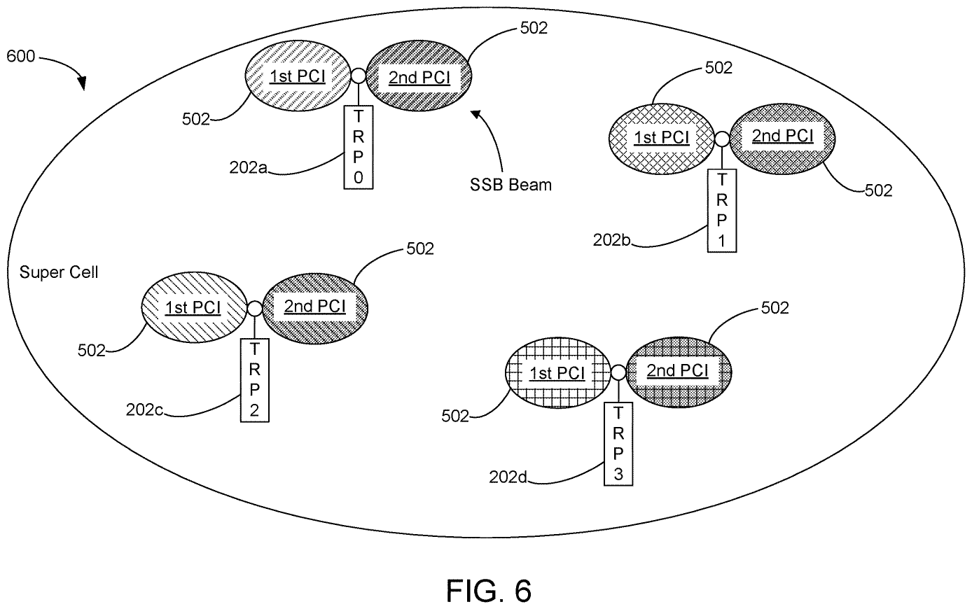

FIG. 6 is a system diagram illustrating a second example of a super cell 600. In FIG. 6, any of the TRPs 202a, 202b, 202c, 202d may transmit multiple same SSBs 402, with a same legacy SSB index but with different PCIs, as SSB beams 502. For example, with SSBs 402 overlapping in time, such as in FIGS. 4A and/or 4C, SSB transmission in FIG. 6 has a TRP 202 which may (e.g., simultaneously) transmit multiple SSBs 402 in the super cell 600 with different PCIs. For example, this may be beneficial since the time a TRP 202 spends transmitting the SSBs may be reduced by half (e.g., as compared to FIG. 5), which may reduce the network power consumption, especially at lower network loads.

In some representative embodiments, a (e.g., any) TRP 202 in a super cell may transmit multiple different SSBs 402 with a same PCI and/or multiple SSBs 402 with a same legacy SSB index with different PCIs. For example, an SSB 402 with a respective legacy SSB index and PCI may be jointly transmitted from multiple TRPs, such as a subset of, or all, TRPs 202 in a super cell. For example, some SSBs 402 may be jointly transmitted by multiple TRPs 202 in the super cell and other SSBs 402 may be transmitted (e.g., only) by individual TRPs 202 in the super cell. In other examples, any other mapping between TRPs 202, panels, and/or antennas and super cell SSBs 402 may be considered.

In certain representative embodiments, a SSB 402 transmitted by a set of cells, P, may be identified by an extended SSB index. For example, the extended SSB index may be determined as a function of any of an SSB index among SSBs 402 with a (e.g., same) PCI (e.g., a legacy SSB index), an index corresponding to a PCI in the set of cells, P, a frequency (e.g., frequency layer) index; and/or a maximum number and/or actually transmitted number of SSBs 402 for the cells in the set of cells, P.

As an example, 64 SSBs may be the maximum number of SSBs supported per PCI and there may be three PCIs used by the set of cells. For the first PCI (e.g., first cell), there may (e.g., only) be 24 SSBs which are actually transmitted. For example, the SSBs 402 transmitted with the first PCI may have SSB indices of {0, 1, 2, 3, 4, 6, 7, 8, 9, 10, 11, 12, 13, 14, 15, 48, 49, 50, 51, 52, 53, 54, 55, 55}. For the second PCI (e.g., second cell), there may (e.g., only) be 36 SSBs which are actually transmitted. For example, the SSBs 402 transmitted with SSB indices the second PCI may have of {0, 1, 2, 3, 4, 6, 7, 8, 9, 10, 11, 12, 13, 14, 15, 32, 33, 34, 35, 36, 37, 38, 39, 40, 41, 42, 43, 44, 45, 46, 47, 60, 61, 62, 63}. For the third PCI (e.g., third cell), there may (e.g., only) be 32 SSBs which are actually transmitted. For example, the SSBs 402 transmitted with the third PCI may have SSB indices of {32, 33, 34, . . . , 62, 63}. A set of extended SSB indices may be created for the 92 actually transmitted SSBs as {0, 1, 2, . . . 91} where the extended SSB indices 0 to 23 correspond to the 24 SSB indices in the first cell, the extended SSB indices 24 to 59 correspond to the 36 SSB indices in the second cell, and the extended SSB indices 60-91 correspond to the 32 SSB indices in the third cell.

For example, the number of extended SSB indices (e.g., 92 indices for the 92 SSBs/SSB beams in the super cell) is higher than the maximum number of SSBs (e.g., 64 SSBs) supported per cell/PCI. The network and the WTRU 102 may use the extended SSB indices for signaling.

In certain representative embodiments, joint transmission by multiple TRPs 202 may correspond to a single frequency network (SFN) transmission, such as where the TRPs 202 transmit a same signal and/or channel. In some embodiments, joint transmission by multiple TRPs 202 may correspond to transmission of different signals and/or channels on overlapping time-frequency resources, such as by using different antenna ports associated with PDSCH transmission.

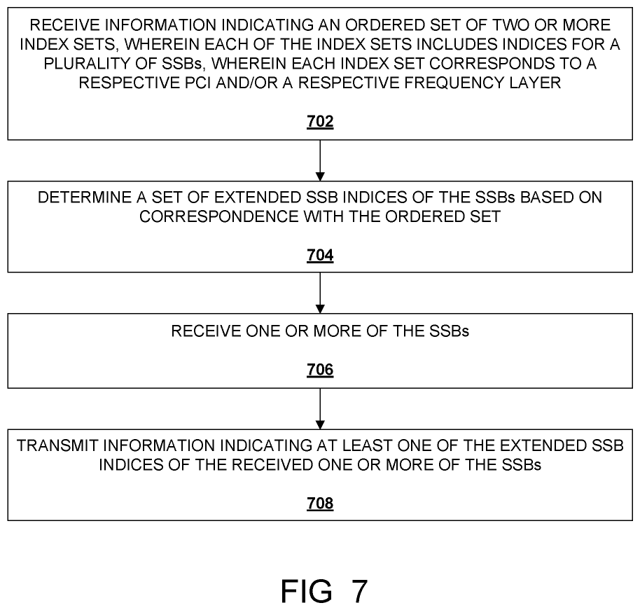

FIG. 7 is a procedural diagram illustrating an example process of a WTRU 102 receiving SSBs 402 using extended SSB indices. As shown in FIG. 7, the WTRU 102 may receive (e.g., from a TRP 202) information indicating an ordered set of two or more index sets at 702. Each of the index sets may include respective indices for a plurality of SSBs 402. Each index set may correspond to a respective PCI (e.g., a PCI in [symbol] ) and/or a respective frequency layer. For example, each index set may correspond to a set of legacy indices (e.g., i_{leg}). At 704, the WTRU 102 may determine a set of extended SSB indices (e.g., i_{leg}+pN_{SSB}) of the SSBs 402 based on correspondence with the ordered set at 706, the WTRU 102 may receive one or more of the SSBs 402. At 708, the WTRU 102 may transmit information indicating at least one of the extended SSB indices of the received one or more of the SSBs 402. For example, at 708, the WTRU 102 may include measurement information (e.g., highest RSRP, best beam) associated with the indicated extended SSB indices of the SSBs received at 706.

For example, the set of the extended SSB indices may sequentially correspond to the SSBs 402 indicated by the two or more index sets.

For example, a first subset of the extended SSB indices may sequentially correspond to a first index set of the two or more index sets and a second subset of the extended SSB indices may sequentially correspond to a second index set of the two or more index sets based on the ordered set.

For example, the first subset of the extended SSB indices may be lower than the second subset of the extended SSB indices. As an example, the first subset may be determined as extended SSB indices 0-63 and the second subset may be determined as extended SSB indices 64-127.

For example, before receiving the information indicating the ordered set of the two or more index sets of SSBs at 702, the WTRU 102 may receive at least one of the SSBs 402 which includes a physical broadcast channel (PBCH) transmission.

For example, the information indicating the ordered set of the two or more index sets of the SSBs 402 may be included in system information (e.g., inOneGroup and/or groupPresence) or a RRC message (e.g., a reconfiguration message).

For example, the information indicating the ordered set of the two or more index sets of the SSBs 402 may include one or more bitmaps indicating each of the two or more index sets (e.g., 4-bits, 8-bits, 64-bits which indicate per SSB whether the SSB is actually transmitted or not).

For example, the set of extended SSB indices may include more than sixty-four SSB indices.

For example, each of the two or more index sets may not include more than 8 SSB indices, such as for FR1. For example, each of the two or more index sets may not include more than sixty-four SSB indices, such as for FR2.

For example, the receiving of the one or more of the SSBs 402 may include receiving at least one SSB 402 indicated by a first index set corresponding to a first PCI and/or a first frequency layer and receiving at least one SSB 402 indicated by a second index set corresponding to a second PCI and/or a second frequency layer. As shown in FIG. 5, the first PCI may be associated with a first TRP (e.g., TRP #0 202a) and the second PCI may be associated with a second TRP (e.g., TRP #2 202c). As shown in FIG. 6, the first PCI may be used by multiple TRPs (e.g., TRP #0 202a and TRP #1 202b) and the second PCI may be used by multiple TRPs (e.g., TRP #0 202a and TRP #1 202b).

For example, the receiving of the one or more of the SSBs 402 may include receiving a first SSB 402 associated with a first PCI using first time and frequency resources and receiving a second SSB 402 associated with a second PCI using the first time and frequency resources (e.g., as in FIG. 4A).

For example, the receiving of the one or more of the SSBs 402 may include receiving a first SSB 402 associated with a first PCI using first time resources and first frequency resources and receiving a second SSB 402 associated with a second PCI using second time resources and the first frequency resources (e.g., as in FIG. 4B).

For example, the receiving of the one or more of the SSBs 402 may include receiving a first SSB associated with a first PCI using first time resources and first frequency resources and receiving a second SSB associated with a second PCI using the first time resources and second frequency resources (e.g., as in FIG. 4C).

For example, the receiving of the one or more of the SSBs 402 may include receiving a first SSB associated with a first PCI using first time and frequency resources and receiving a second SSB associated with a second PCI using second time and frequency resources which do not overlap with the first time and frequency resources (e.g., as in FIG. 4D).

For example, the receiving of the one or more of the SSBs 402 may include receiving a first SSB 402 associated with a first PCI from a first TRP 202 and receiving a second SSB 402 associated with a second PCI from the first TRP 202 (e.g., as in FIG. 6).

For example, the receiving of the one or more of the SSBs 402 may include receiving a first SSB 402 associated with a first PCI from a first TRP 202 and receiving a second SSB 402 associated with a second PCI from a second TRP 202 (e.g., as in FIG. 5).

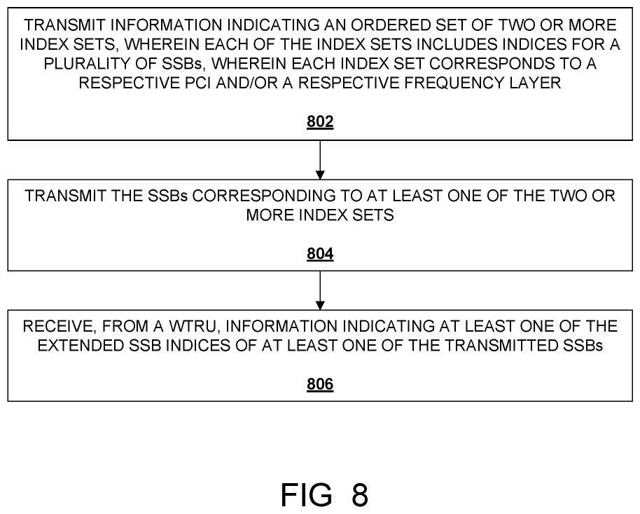

FIG. 8 is a procedural diagram illustrating an example process of a TRP 202 sending SSBs 402 using extended SSB indices. As shown in FIG. 8, the TRP 202 may transmit information indicating an ordered set of two or more index sets at 802. Each of the index sets includes indices for a plurality of SSBs 402. Each index set may correspond to a respective physical cell identifier (PCI) and/or a respective frequency layer. At 804, the TRP 202 may transmit the SSBs 402 corresponding to at least one of the two or more index sets. For example, the TRP 202 may only transmit SSBs 402 which correspond to a first PCI (e.g., only one index set), such as shown in FIG. 5. For example, the TRP 202 may transmit SSBs 402 which correspond to multiple PCIs (e.g., multiple index sets), such as shown in FIG. 6. At 806, the TRP 202 may receive, from a WTRU 102, information indicating at least one of the extended SSB indices of at least one of the transmitted SSBs 402.

For example, the set of the extended SSB indices may sequentially correspond to the SSBs 402 indicated by the two or more index sets.

For example, a first subset of the extended SSB indices may sequentially correspond to a first index set of the two or more index sets and a second subset of the extended SSB indices may sequentially correspond to a second index set of the two or more index sets based on the ordered set.

For example, the first subset of the extended SSB indices may be lower than the second subset of the extended SSB indices. As an example, the first subset may be determined as extended SSB indices 0-63 and the second subset may be determined as extended SSB indices 64-127.

For example, the TRP 202 may transmit at least one of the SSBs 402 which includes a physical broadcast channel (PBCH) transmission.

For example, the information indicating the ordered set of the two or more index sets of the SSBs 402 may be included in system information (e.g., inOneGroup and groupPresence) or a RRC message (e.g., a reconfiguration message).

For example, the information indicating the ordered set of the two or more index sets of the SSBs 402 may include one or more bitmaps indicating each of the two or more index sets (e.g., 4-bits, 8-bits, 64-bits which indicate per SSB whether the SSB is actually transmitted or not).

For example, the set of extended SSB indices may include more than sixty-four SSB indices.

For example, each of the two or more index sets may not include more than 8 SSB indices, such as for FR1. For example, each of the two or more index sets may not include more than sixty-four SSB indices, such as for FR2.

For example, the transmitted SSBs 402 may include transmitting at least one SSB 402 indicated by a first index set corresponding to a first PCI and/or a first frequency layer and transmitting at least one SSB 402 indicated by a second index set corresponding to a second PCI and/or a second frequency layer. As shown in FIG. 5, the first PCI may be associated with a first TRP (e.g., TRP #0 202a) and the second PCI may be associated with a second TRP (e.g., TRP #2 202c). As shown in FIG. 6, the first PCI may be used by multiple TRPs (e.g., TRP #0 202a and TRP #1 202b) and the second PCI may be used by multiple TRPs (e.g., TRP #0 202a and TRP #1 202b).

For example, the transmitting of the one or more of the SSBs 402 by the TRP 202 at 804 may be performed as shown in any of FIGS. 4A to 4D.

For example, the transmitting of the one or more of the SSBs 402 by the TRP 202 at 804 may be performed as shown in any of FIGS. 5 and 6.

In certain representative embodiments, a WTRU 102 may implement a method (e.g., as a procedure) which includes receiving one or more transmissions of one or more SSBs 402 (e.g., SSB beams 502) which include information indicating a MIB. The one or more SSBs 402 may be based on one or more PCIs of a set of PCIs associated with a plurality of TRPs. The WTRU 102 may receive, based on the MIB, a transmission including information indicating system information.

In certain representative embodiments, the WTRU 102 may further receive a transmission including (e.g., information indicating) system information including information indicating a plurality of available SSBs 402 associated with the set of PCIs.

In certain representative embodiments, the WTRU 102 may further determine SSB index information for the one or more SSBs 402 based on first index information associated with the one or more SSBs 402 and second index information associated with PCIs, of the set of PCIs, corresponding to the one or more SSBs 402.

In certain representative embodiments, the receiving of the one or more transmissions of the one or more SSBs 402 may include receiving a first plurality of SSBs 402 associated with a first PCI of the set of PCIs and receiving a second plurality of SSBs 402 associated with a second PCI of the set of PCIs. For example, the first plurality of SSBs 402 may be received using first time and frequency resources, and the second plurality of SSBs 402 may be received using the first time and frequency resources. For example, the first plurality of SSBs 402 may be received using first time resources and first frequency resources, and the second plurality of SSBs 402 may be received using the (e.g., same) first time resources and second frequency resources different from (e.g., non-overlapping) the first frequency resources. For example, the first plurality of SSBs 402 may be received using first time resources and first frequency resources, and the second plurality of SSBs 402 may be received using second time resources, different from (e.g., non-overlapping) the first time resources, and the first frequency resources. For example, the first plurality of SSBs 402 may be received using first time and frequency resources, and the second plurality of SSBs 402 may be received using second time and frequency resources different from (e.g., non-overlapping) the first time and frequency resources.

In certain representative embodiments, the reception of the one or more transmissions of the one or more SSBs 402 may be based on monitoring frequency resources according to a global synchronization channel number (GSCN).

In certain representative embodiments, the reception of the one or more transmissions of the one or more SSBs 502 may be based on monitoring frequency resources according to an operating frequency of the WTRU 102.

In certain representative embodiments, a WTRU 102 may implement a method (e.g., as a procedure) which includes receiving a transmission including information indicating system information or a RRC configuration. The system information or the RRC configuration may include information indicating a plurality of available SSBs associated with a set of PCIs. The WTRU 102 may receive one or more transmissions of one or more of the available SSBs 402. For example, the received SSBs 402 may include information indicating a MIB.

In certain representative embodiments, the WTRU 102 may further determine SSB index information for the plurality of available SSBs 402 based on first index information associated with the plurality of available SSBs 402 and second index information associated with the set of PCIs.

In certain representative embodiments, the system information or the RRC configuration may include information indicating position information of the plurality of available SSBs 402 and/or group information of the plurality of available SSBs 402. For example, the position information may be associated with a respective PCI of the set of PCIs, a subset of the set of PCIs, or all of the set of PCIs. For example, the group information may be associated with a respective PCI of the set of PCIs, a subset of the set of PCIs, or all of the set of PCIs.

In certain representative embodiments, a WTRU 102 may implement a method (e.g., as a procedure) which includes receiving one or more first transmissions of one or more SSBs 402 which include (e.g., information indicating) a MIB. The one or more SSBs 402 may be based on one or more PCIs of a set of PCIs associated with a plurality of TRPs 202. The WTRU 102 may determine an SSB index for one of the SSBs 402 based on first index information associated with the one of the SSBs 402 and second index information associated with a PCI, of the set of PCIs, corresponding to the one of the SSBs 402. The WTRU 102 may receive information indicating the SSB index. The WTRU 102 may perform processing using the one of the SSBs 402 based on the indicated SSB index.

In certain representative embodiments, the first index information may be based on a demodulation reference signal associated with the one of the SSBs 402 and/or a payload of the one of the SSBs 402.

In certain representative embodiments, the second index information may be based on any of a number of available SSBs 402, an operating frequency of the WTRU 102, and/or the PCI corresponding to the one of the SSBs 402.

In certain representative embodiments, the processing may include sending a transmission using QCL information associated with the indicated SSB index.

In certain representative embodiments, the processing may include receiving a transmission using QCL information associated with the indicated SSB index.

In certain representative embodiments, the processing may include reporting channel state information (CSI) for the one of the SSBs 402 associated with the indicated SSB index.

In certain representative embodiments, a TRP 202 may implement a method (e.g., as a procedure) which includes transmitting a plurality of SSBs 402 which include (e.g., information indicating) a MIB. Each SSB 402 of the plurality of SSBs 402 may be based on a respective PCI of a set of PCIs associated with a plurality of TRPs (e.g., providing a super cell).

In certain representative embodiments, the TRP 202 may further transmit a plurality of demodulation reference signals (DMRSs) associated with the plurality of SSBs 402. SSB index information of the plurality of SSBs 402 may be based on (1) first index information based on the plurality of DMRSs and physical broadcast channel payloads of the SSBs 402, and (2) the set of PCIS.

In certain representative embodiments, the transmitting (e.g., of the SSBs 402) may include transmitting a first subset of the plurality of SSBs 402 based on a first PCI of the set of PCIs, and transmitting a second subset of the plurality of SSBs 402 based on a second PCI of the set of PCIs. For example, the first subset and the second subset may be transmitted using overlapping time and frequency resources. For example, the first subset and the second subset may be transmitted using overlapping frequency resources. For example, the first subset and the second subset may be transmitted using overlapping time resources. For example, the first subset and the second subset may be transmitted using non-overlapping time and non-overlapping frequency resources.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented by a wireless transmit/receive unit (WTRU), the method comprising:
receiving information indicating an ordered set of two or more index sets, wherein each of the index sets includes indices for a plurality of synchronization signal blocks (SSBs), wherein each index set corresponds to a respective physical cell identifier (PCI) and a respective frequency layer;
determining a set of extended SSB indices of the SSBs based on correspondence with the ordered set;
receiving one or more of the SSBs; and
transmitting information indicating at least one of the extended SSB indices of the received one or more of the SSBs.

2. The method of claim 1, wherein the set of the extended SSB indices sequentially correspond to the SSBs indicated by the two or more index sets.

3. The method of claim 1, wherein a first subset of the extended SSB indices sequentially correspond to a first index set of the two or more index sets and a second subset of the extended SSB indices sequentially correspond to a second index set of the two or more index sets based on the ordered set.

4. The method of claim 3, wherein the first subset of the extended SSB indices are lower than the second subset of the extended SSB indices.

5. The method of claim 1, further comprising:
before the receiving of the information indicating the ordered set of the two or more index sets of SSBs, receiving at least one of the SSBs which includes a physical broadcast channel (PBCH) transmission.

6. The method of claim 1, wherein the information indicating the ordered set of the two or more index sets of the SSBs is included in system information or a radio resource control message.

7. The method of claim 1, wherein the information indicating the ordered set of the two or more index sets of the SSBs include one or more bitmaps indicating each of the two or more index sets.

8. The method of claim 1, wherein the set of extended SSB indices includes more than sixty-four SSB indices.

9. The method of claim 1, wherein each of the two or more index sets includes no more than sixty-four SSB indices.

10. The method of claim 1, wherein the receiving the one or more of the SSBs includes receiving at least one SSB indicated by a first index set corresponding to a first PCI and/or a first frequency layer and receiving at least one SSB indicated by a second index set corresponding to a second PCI and/or a second frequency layer.

11.-16. (canceled)

16. A wireless transmit/receive unit (WTRU) comprising:
a processor, memory, and a transceiver which are configured to:
receive information indicating an ordered set of two or more index sets, wherein each of the index sets includes indices for a plurality of synchronization signal blocks (SSBs), wherein each index set corresponds to a respective physical cell identifier (PCI) and a respective frequency layer,
determine a set of extended SSB indices of the SSBs based on correspondence with the ordered set,
receive one or more of the SSBs, and
transmit information indicating at least one of the extended SSB indices of the received one or more of the SSBs.

17. The WTRU of claim 16, wherein the set of the extended SSB indices sequentially correspond to the SSBs indicated by the two or more index sets.

18. The WTRU of claim 16, wherein a first subset of the extended SSB indices sequentially correspond to a first index set of the two or more index sets and a second subset of the extended SSB indices sequentially correspond to a second index set of the two or more index sets based on the ordered set.

19. The WTRU of claim 18, wherein the first subset of the extended SSB indices are lower than the second subset of the extended SSB indices.

20. The WTRU of claim 16, wherein the processor, memory and transceiver are configured to:
before the reception of the information indicating the ordered set of the two or more index sets of SSBs, receive at least one of the SSBs which includes a physical broadcast channel (PBCH) transmission.

21. The WTRU of claim 16, wherein the information indicating the ordered set of the two or more index sets of the SSBs is included in system information or a radio resource control message.

22. The WTRU of claim 16, wherein the information indicating the ordered set of the two or more index sets of the SSBs include one or more bitmaps indicating each of the two or more index sets.

23. The WTRU of claim 16, wherein the set of extended SSB indices includes more than sixty-four SSB indices.

24. The WTRU of claim 16, wherein each of the two or more index sets includes no more than sixty-four SSB indices.

25. The WTRU of claim 16, wherein the processor, memory, and transceiver are configured to receive the one or more of the SSBs which includes to receive at least one SSB indicated by a first index set corresponding to a first PCI and/or a first frequency layer and receive at least one SSB indicated by a second index set corresponding to a second PCI and/or a second frequency layer.

26.-31. (canceled)
